(19) United States
(12) Patent Application Publication
(10) Pub. No.: US 2013/0125051 A1
(43) Pub. Date: May 16, 2013

(54) Historical review using manipulable visual indicators

(71) Applicants: Yohko A. F. Kelley, Woodinville, WA (US); Ethan A. Eismann, Oakland, CA (US)

(72) Inventors: Yohko A. F. Kelley, Woodinville, WA (US); Ethan A. Eismann, Oakland, CA (US)

(73) Assignee: Adobe Systems Incorporated, San Jose, CA (US)

(21) Appl. No.: 11/904,874

(22) Filed: Sep. 28, 2007

(51) Int. Cl. G06F 3/048

(52) U.S. Cl. 715/810

(57) ABSTRACT

Historical review using manipulable visual indicators is described, including providing a visual indicator of activity associated with a file, the visual indicator being presented as a function of time, presenting an element associated with the visual indicator, the element being configured to be manipulated by an input device, and manipulating the element associated with the visual indicator, the element being configured to send a request to access data associated with one or more versions of the file when positioned relative to a portion of the visual indicator.

### FIELD OF THE INVENTION

The present invention relates generally to computer programs and software applications, and document editing and authoring. More specifically, techniques for historical review using manipulable visual indicators are described.

### BACKGROUND OF THE INVENTION

Conventionally, reviewing a history of edits, changes, or other modifications to a set of data, document, file or the like (“file”) is often problematic using most conventional document authoring and editing applications. Where various users are working on a single document, the history of accesses to the file is important, particularly if a user wishes to determine whether there are any patterns of edits, changes, modifications, or the like. Further, as an aid in the editing process, a history of accesses is often used to view changes that were made to a file by other users. Further, a history of accesses allows other users to understand when and who made these changes. Conventional project management, version control, editing/authoring applications and other conventional techniques are limited in functionality or are poorly represented visually, often creating display environments using pop-up windows, boxes, dialog boxes, and other user interfaces that disrupt context and workflow.

Some conventional techniques provide lists or menu-selected histories of accesses to a file. Lists, in conventional applications, are typically selected from a pull-down menu or other type of text-based list, which do not enable users to visually see patterns of activity (e.g., activity level, bursts of activity, periods of inactivity, and others) or provide comprehensive historical information or disrupt the workflow or on-screen context (e.g., when an access occurred, user identification for each access, the reason for the access, the event or action (e.g., addition, deletion, modification) that occurred during the access) associated with a file. Further, conventional techniques are limited in the amount of historical information associated with a document that is displayed.

Conventional techniques typically do not provide a complete history of accesses, requiring users to manually sift through individual versions of a document to comprehensively determine what edits are made to a file. Conventional techniques can create labor-intensive efforts if multiple users are working on a given document. Further, conventional applications are confusing and difficult to use when trying to view a history of events, actions, or accesses (“accesses”) of a file. Using conventional techniques, users must manually sift through lists of accesses or other events and actions to view a complete history for a document. Further, historical information, in some conventional techniques, is altogether not available.

Thus, a solution for viewing historically reviewing a file without the limitations of conventional techniques is needed.

### BRIEF DESCRIPTION OF THE DRAWINGS

Various examples are disclosed in the following detailed description and the accompanying drawings:

FIG. 1 illustrates an exemplary system configured to implement historical review using manipulable visual indicators;

FIG. 2 illustrates an exemplary application architecture configured to implement historical review using manipulable visual indicators;

FIG. 3A illustrates an exemplary interface having a manipulable visual indicator;

FIG. 3B illustrates a further exemplary interface having a manipulable visual indicator;

FIG. 4 illustrates an exemplary process for historical review using manipulable visual indicators;

FIG. 5 illustrates an exemplary process for historical review using manipulable visual indicators; and

FIG. 6 illustrates an alternative exemplary computer system suitable for historical review using manipulable visual indicators.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the embodiments has not been described in detail to avoid unnecessarily obscuring the description.

In some examples, the described techniques may be implemented as a computer program or application (“application”) or as a module or sub-component of another application. The described techniques may be implemented as software, hardware, firmware, circuitry, or a combination thereof. If implemented as software, the described techniques may be implemented using various types of programming, development, scripting, or formatting languages, platforms, frameworks, syntax, applications, protocols, objects, or techniques, including C, Objective C, C++, C#, AIR™ FleX™, Java™, Javascript™, Ajax, COBOL, Fortran, ADA, XML, HTML, DHTML, XHTML, HTTP, XMPP, and others. Design, publishing, and other types of applications such as Dreamweaver®, Shockwave®, Flash®, and Fireworks® may also be used to implement the described techniques. The described techniques may be varied and are not limited to the examples or descriptions provided.

Historical review using manipulable visual indicators is described. Various techniques are described, including presenting a visual indicator of a history of edits, additions, deletions, or other accesses (“accesses”) to a file and a manipulable visual element (e.g., a slide bar or other displayed (i.e., on-screen) icon, widget, or element (“element”) that may be moved or positioned relative to each other. When moved, positioned, or otherwise manipulated (“manipulated”), a manipulable visual element enables a user to see a graphical representation of the amount of activity or accesses of a file over a period or interval of time during which the file is connected (i.e., when a file began recording a history of accesses or when a file was first stored at a location accessible by an application configured to track a history of accesses of the file). Further, by manipulating the visual element over a portion of the visual indicator, the number of accesses, accessing user identification, date of user access, summary of type of user access, or other information may be presented, providing a historical summary review of accesses of a file at a given point in time. In some examples, a visual indicator may be implemented as a chart measuring time along a horizontal or X-axis and activity along a vertical or Y-axis. When manipulated to a given time period along the X-axis, the manipulable visual element (e.g., a slide bar) may invoke a panel that expands outwards from a main panel to show information such as that described. In other examples, the described techniques may be implemented differently in design, function, layout, order, or configuration and are not limited to the examples provided.

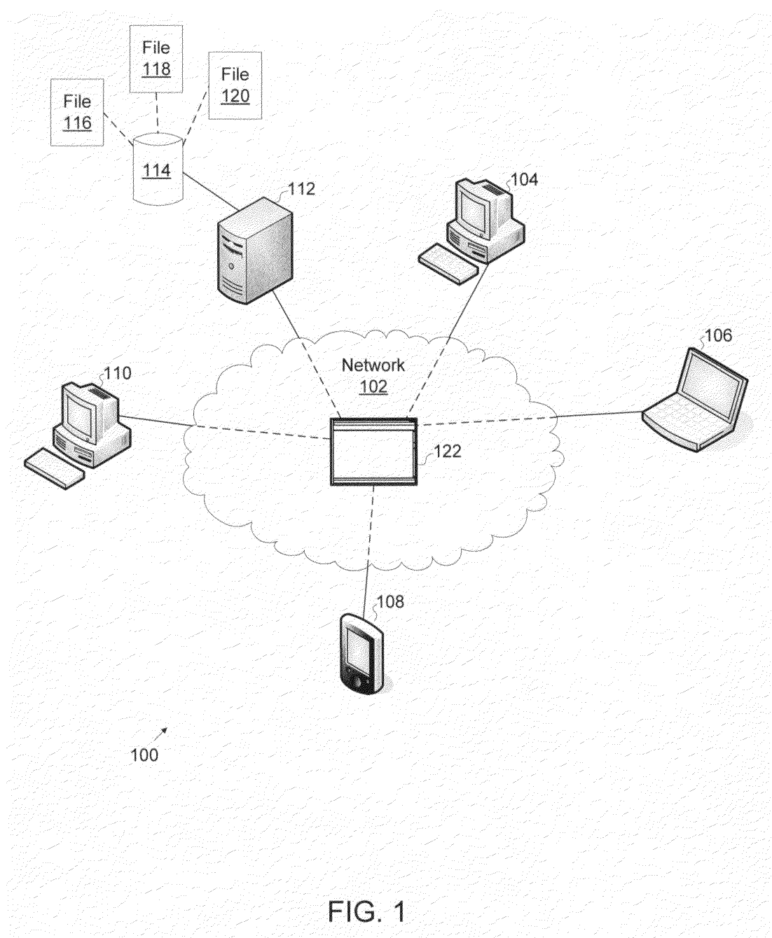

FIG. 1 illustrates an exemplary system configured to implement historical review using manipulable visual indicators. Here, system 100 includes network 102, clients 104-110, server 112, repository 114 (i.e., storing files 116-120), and graphical user interface (“interface”) 122. In some examples, interface 122 may be accessed from any type of endpoint, device, client, peer, or the like, including clients 104-110. Clients 104-110 may be wired, wireless, mobile, and in data communication with server 112 using any type of public or private data network or topology. In other examples, the number, type, configuration, and topology of system 100, network 102, clients 104-110, and server 112 may be varied and are not limited to the descriptions provided.

Here, any of clients 104-110 and server 112 may access files 116-120 using interface 122. In some examples, interface 122 may be associated with a common, shared, or otherwise connected (“connected”) application that allows users to view, read, and access other users' input (i.e., edits, additions, deletions, or other modifications). For example, a user on client 104 may be working with an application rendering interface 122 to access file 118 from server 112 and repository 114. While working with interface 122, accesses to file 118 from, for example, client 106-110 may be viewed using the techniques described herein. Further, accesses may be viewed as a history or list of accesses to a given file and, when an individual access is selected, the individual access may be presented and viewed. Still further, a visual element disposed over a visual indicator may be manipulated to navigate through a history of accesses to, for example, files 116-120. In other examples, system 100 and the above-described elements may be implemented differently and are not limited to the descriptions provided.

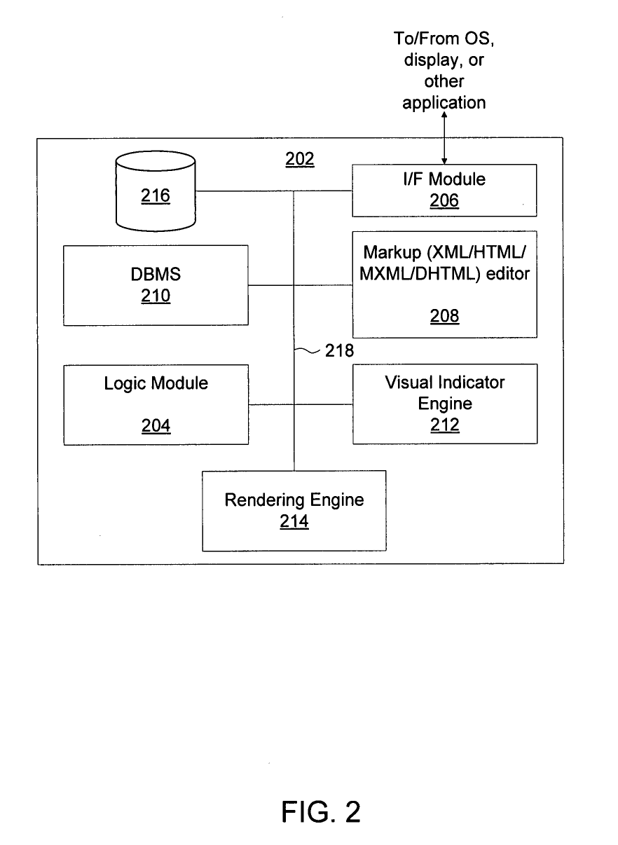

FIG. 2 illustrates an exemplary application architecture configured to implement historical review using manipulable visual indicators. Here, application 202 includes logic module 204, interface (I/F) module 206, markup editor 208, database management system 210, visual indicator engine 212, rendering engine 214, repository 216, and bus 218. In some examples, repository 216 may be implemented similarly or substantially similarly to repository 114 (FIG. 1) as a database, data mart, data warehouse, storage area network (SAN), redundant array of independent disks (RAID), or other storage facility. In other examples, repository 216 may be implemented differently than as described above.

Here, logic module 204 is configured to manage interface (I/F) module 206, markup editor 208, database management system 210, visual indicator engine 212, rendering engine 214, and repository 216 by exchanging control signals and data over bus 218. In some examples, I/F module 206 provides data input from and output to an operating system, display, or other application configured to implement application 202. Data input to I/F module 206 may be associated with an access and, using any type of markup language (e.g., XML, HTML, MXML, and others), interpreted using markup editor 208. Likewise, markup editor 208 may also be used to assign or “wrap” various markup language elements (e.g., tags) to data or other information changed, added, or deleted to a file (e.g., files 116-120 (FIG. 1)), which may also be stored in repository 216 using, for example, database management system (DBMS) 210. Data or information output from I/F module 206 may be rendered using rendering engine 214.

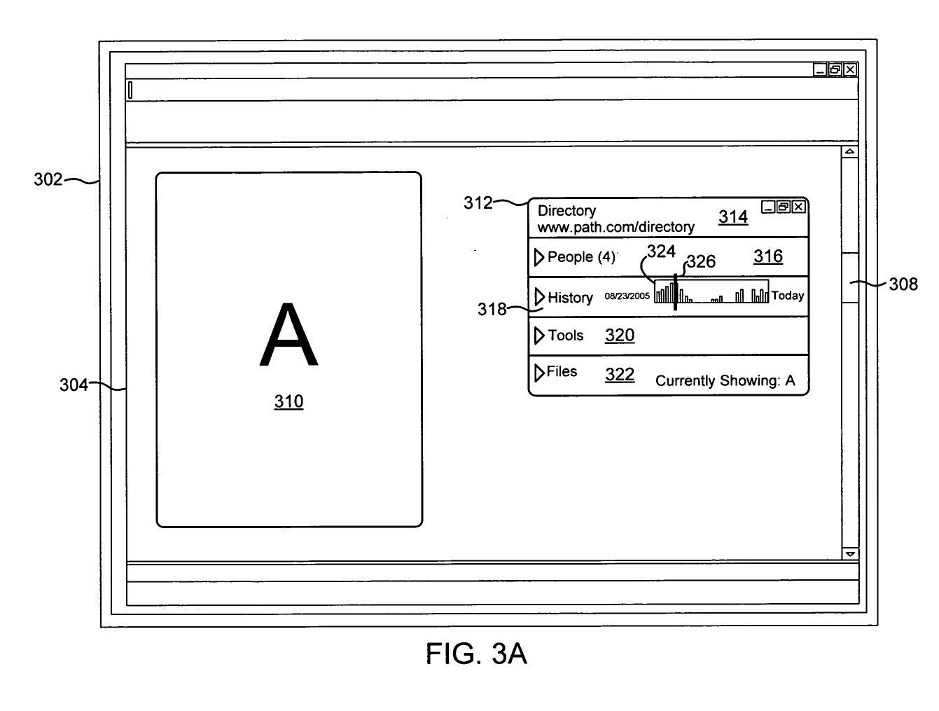

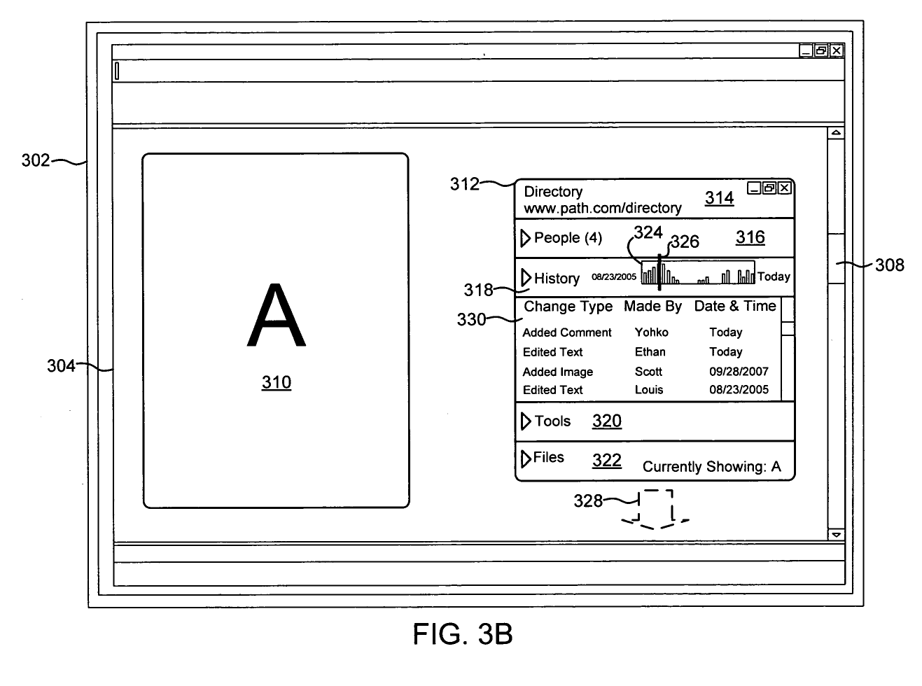

In some examples, a visual indicator (e.g., a chart, timeline, calendar, clock, or any type of visual or graphical representation of activity (e.g., access to a file to add, delete, change, read, or others)) may be generated by visual indicator engine 212 and rendered and displayed by rendering engine 214 and I/F module 206 to a display (not shown). Further, a manipulable visual element (e.g., a slide bar on a chart that may be moved, such as that described below in connection with FIGS. 3A-3B) may also be generated by visual indicator engine 212. Still further, visual indicator engine 212 may be configured to received, interpret, handle, or otherwise manage input received from an interface (e.g., interface 122 (FIG. 1)) when a visual element is manipulated (i.e., moved, positioned, oriented, and the like) relative to a visual indicator. Interpreting the position of a visual element relative to a visual indicator may be performed by visual indicator engine 212, which can access repository 216 using DBMS 210, the latter of which may be optionally implemented with repository 216 or altogether omitted, to retrieve data or information associated with accesses related to the position of the visual element over the visual indicator. In other examples, application 202 and the above-described elements may be implemented differently and are not limited to the descriptions provided.

FIG. 3A illustrates an exemplary interface having a manipulable visual indicator. Here, interface 302 includes display 304, scroll bar 308, document 310, palette 312, regions 314-322, visual indicator 324, and visual element 326. In some examples, document 310 is associated with a file (not shown) that may be connected by loading one or more versions of the document to a repository or other managed, centralized location from which one or more users may access the file to view document 310. Further, when document 310 is presented, palette 312 may also be presented, the latter of which is configured to present information associated with document 310 in regions 314-322. For example, regions 314-322 are configured to present information associated with a directory path, users (i.e., people) accessing the file (i.e., document 310), historical review or presentation of accesses, tools, and files being presented (i.e., “Currently Showing: A (i.e., document 310)). In other examples, more, fewer, or different regions other than regions 314-322 may be implemented and are not limited to those shown and described.

In some examples, when palette 312 is presented, visual indicator 324 and visual element 326 are also presented. Here, visual indicator 324 is indicated as a chart that begins at the date “Aug. 23, 2005” and ends at the present day (i.e., “Today”). Plotted along the chart of visual indicator 324 are individual vertical bars. Each bar is plotted at a given time period or interval and the magnitude is representative of the number of accesses of the current file (i.e., “A” or document 310). When visual element 326, which is implemented as a slide bar, is manipulated, moved, or otherwise positioned (“manipulated”) along visual indicator 324, additional information associated with document 310 may be presented, as described in greater detail below in connection with FIG. 3B. Visual element 326 may be manipulated using any type of input/output device (e.g., mouse, keyboard, touchpad, voice recognition, or others). In other examples, the appearance, layout, design, form, or other features or attributes of interface 302, document 310, palette 312 and the described elements may be varied and are not limited to the descriptions provided.

FIG. 3B illustrates a further exemplary interface having a manipulable visual indicator. Here, interface 302 includes display 304, scroll bar 308, document 310, palette 312, regions 314-322, visual indicator 324, visual element 326, arrow 328, and sub-region 330. In some examples, a user may manipulate an input/output device, as described above, to expand palette 312 in the direction of arrow 328 to allow sub-region 330 to visually expand from the bottom border of region 318 (“History”). Sub-region 330 may be presented using any type of visual effects or appearance and are not limited to the examples shown and described. Sub-region 330 may also be invoked (i.e., presented by expanding from the bottom border of region 316) using any type of technique (e.g., clicking on an icon, manipulating a set of directional arrows (not shown), or others) and is not limited to those shown and described.

As shown here, when palette 312 expands and sub-region 310 is presented, various types of information may be presented. For example, the type of change made to document 310, the user making the change, and the date and time of the change may be presented in sub-region 330. Further, when visual element 326 is manipulated over visual indicator 326, the information presented in sub-region 330 may change. For example, if visual element 326 is manipulated over visual indicator 324 to the right end of the chart, changes made today are presented in sub-region 330. Still further, the user names are also changed and the date and time of the changes are modified to reflect “Today.” In some examples, as visual element 326 is manipulated over visual indicator 324, application 202 (FIG. 2) accesses repository 216 to retrieve data and information associated with accesses to a file for document 310, which may be stored as part of the file or in a separate file. When a file is accessed to retrieve a connected document (i.e., document 310), as described above, data and information associated with users who have accessed a file associated with document 310 may be presented in palette 312. Further, by manipulating visual element 326 over visual indicator 324, a set of data may be selected and presented dynamically in sub-region 330. By manipulating visual element 326 over visual indicator 324, historical data and information may be dynamically accessed, retrieved, and presented in palette 330, providing a contextually-relevant display of an access history without having to switch interfaces, displays, or screens. For example, data and information presented in sub-region 330 and palette 312 alongside document 310 may be selected to view additional details. As an example, if a user selects the “Added Comment” made by user “Yohko” on “Today,” sub-region 330 may change to view the comment added. Alternatively, if the “Added Comment” is selected, document 310 may highlight or otherwise indicate the specific comment added. Still further, document 310 may appear differently, revert to a previous version, highlight edits, or use any other technique to identify previous accesses. In other examples, interface 302 and the above-described elements and techniques may be varied and are not limited to those shown and described.

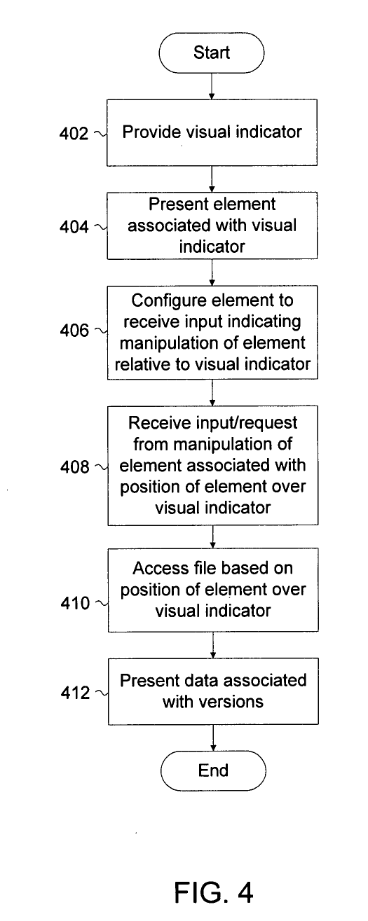

FIG. 4 illustrates an exemplary process for historical review using manipulable visual indicators. Here, a visual indicator (e.g., visual indicator 324 (FIGS. 3A-3B)) is presented (402). An element (e.g., visual element 326 (FIGS. 3A-3B)) is presented over, superimposed on, or otherwise relative to a visual indicator (404). The element is configured to receive an input indicating manipulation of a visual element relative to a visual indicator (406). Once configured, an input is received indicating the visual element has been manipulated relative to the visual indicator (408). Based on the position of the manipulated visual element relative to the visual indicator, a file is accessed, as described above in connection with FIGS. 3A-3B (410). In some examples, accessing a file may be performed by retrieving specific versions, edits, additions, comments, or other input provided by users accessing a connected document (e.g., document 310 (FIGS. 3A-3B) in a networked environment using, for example, a collaborative tool or application. The position of the element relative to the visual indicator may be used to determine what data or information should be accessed and presented. Further, after accessing the file, the retrieved data or information is presented as described above (412). The above-described process and sub-processes may be varied and performed in any arbitrary order and are not limited to the examples shown and described.

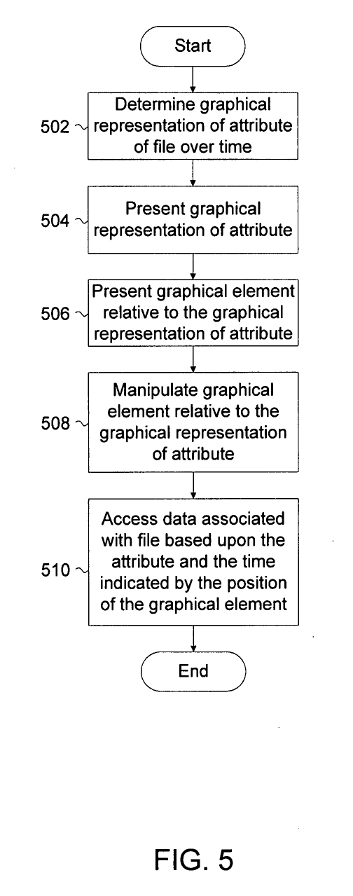

FIG. 5 illustrates an alternative exemplary process for historical review using manipulable visual indicators. Here, a graphical representation of an attribute (e.g., accesses, date/time of access, type of access, and the like) of a file is determined (502). In some examples, a graphical representation of an attribute is presented using techniques such as those described (504). For example, an interactive chart (e.g., visual indicator 324 (FIGS. 3A-3B)) may be presented. As another example, an interactive clock or calendar may also be presented. Alternatively, any other type of visual representation of time may be used, when configured for user interaction, to dynamically access data and information associated with a file.

In some examples, a graphical element (e.g., visual element 326 (FIGS. 3A-3B)) is presented relative to the graphical representation of the attribute (506). Any type of technique (e.g., superimposed, layered, or others) may be used to present a graphical element over the graphical representation. The presented graphical element is manipulated relative to the graphical representation of the attribute (508). For example, a graphical element implemented as a slide bar over a chart (i.e., a graphical representation of an attribute representing activity associated with a file over time) may be manipulated (e.g., dragging using a mouse) to a point on the chart. After manipulating the graphical element to a given point, section, or portion of the graphical representation of the attribute, data associated with a file is accessed (510). In other examples, the above-described process and sub-processes may be varied and performed in any arbitrary order and are not limited to the examples shown and described.

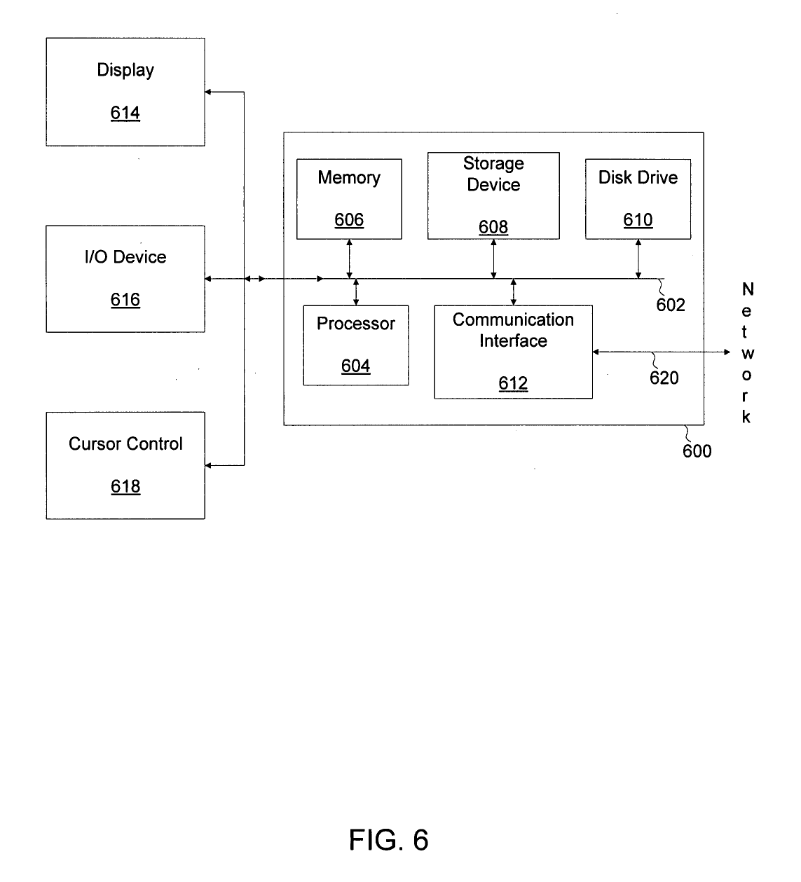

FIG. 6 illustrates an exemplary computer system suitable for historical review using manipulable visual indicators. In some examples, computer system 600 may be used to implement computer programs, applications, methods, processes, or other software to perform the above-described techniques. Computer system 600 includes a bus 602 or other communication mechanism for communicating information, which interconnects subsystems and devices, such as processor 604, system memory 606 (e.g., RAM), storage device 608 (e.g., ROM), disk drive 610 (e.g., magnetic or optical), communication interface 612 (e.g., modem or Ethernet card), display 614 (e.g., CRT or LCD), input device 616 (e.g., keyboard), and cursor control 618 (e.g., mouse or trackball).

According to some examples, computer system 600 performs specific operations by processor 604 executing one or more sequences of one or more instructions stored in system memory 606. Such instructions may be read into system memory 606 from another computer readable medium, such as static storage device 608 or disk drive 610. In some examples, hard-wired circuitry may be used in place of or in combination with software instructions for implementation.

The term “computer readable medium” refers to any medium that participates in providing instructions to processor 604 for execution. Such a medium may take many forms, including but not limited to, non-volatile media, volatile media, and transmission media. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions may be performed by a single computer system 600. According to some examples, two or more computer systems 600 coupled by communication link 620 (e.g., LAN, PSTN, or wireless network) may perform the sequence of instructions in coordination with one another. Computer system 600 may transmit and receive messages, data, and instructions, including program, i.e., application code, through communication link 620 and communication interface 612. Received program code may be executed by processor 604 as it is received, and/or stored in disk drive 610, or other non-volatile storage for later execution.

The foregoing examples have been described in some detail for purposes of clarity of understanding, but are not limited to the details provided. There are many alternative ways and techniques for implementation. The disclosed examples are illustrative and not restrictive.

1. A method, comprising:
displaying a file and a visual indicator of activity associated with a file, the visual indicator being presented as a function of time, wherein the visual indicator of activity indicates a frequency of accesses over a plurality of time intervals;
presenting an element associated with the visual indicator, wherein the element is configured to be manipulated by an input device;
manipulating the element associated with the visual indicator to access data associated with one or more versions of the file when the element is positioned relative to a portion of the visual indicator, wherein the relative positioning of the element corresponds to one of the plurality of time intervals; and
in response to said manipulating, modifying the display of the file with the accessed data to a state corresponding to a time of the corresponding one of the plurality of time intervals.

2. The method of claim 1, wherein the visual indicator is a chart.

3. The method of claim 1, wherein the visual indicator is a clock.

4. The method of claim 1, wherein the visual indicator is a calendar.

5. The method of claim 1, wherein the visual indicator comprises one or more vertical bars, each of the one or more vertical bars having a magnitude configured to correspond to a level of the activity.

6. The method of claim 1, wherein the file is a document.

7. The method of claim 1, wherein the file is a connected document.

8. The method of claim 1, wherein the file is a connected document stored at a location, the location being accessed when the element is manipulated relative to the visual indicator.

9. The method of claim 1, wherein the element is a slide bar.

10. The method of claim 1, wherein manipulating the element over the visual indicator further comprises accessing one or more versions of the file, the one or more versions being determined by a position of the element relative to the visual indicator.

11. The method of claim 1, wherein the data is associated with one or more accesses of the file.

12. The method of claim 1, wherein the data is displayed in a panel presented substantially adjacent to the visual indicator.

13. The method of claim 1, wherein the data comprises a history of accesses of the file associated with a time interval on the visual indicator.

14. The method of claim 1, wherein the data comprises identification of one or more users accessing the file at a time interval on the visual indicator.

15. A method, comprising:
displaying a file;
graphically representing a number of accesses of the file per time interval for a plurality of time intervals;
presenting a graphical element configured to access data associated with one or more versions of the file when the graphical element is manipulated relative to a graphical representation of the file accesses for the plurality of time intervals, wherein the relative positioning of the element corresponds to one of the plurality of time intervals;
manipulating the graphical element, wherein said manipulating causes one or more documents associated with the file to be accessed to modify the display of the file to a state corresponding to a time of the corresponding one of the plurality of time intervals.

16. (canceled)

17. The method of claim 15, further comprising displaying the data, wherein the data is associated with a position of the graphical element relative to the graphical representation.

18. A system, comprising:
a database configured to store data; and
a processor configured to:
display a file and a visual indicator of activity associated with a file, the visual indicator being presented as a function of time, wherein the visual indicator of activity indicates a frequency of accesses over a plurality of time intervals;
present an element associated with the visual indicator, wherein the element is configured to be manipulated by an input device;
manipulate the element associated with the visual indicator to access data associated with one or more versions of the file when the element is positioned relative to a portion of the visual indicator, wherein the relative positioning of the element corresponds to one of the plurality of time intervals; and
in response to said manipulating, modify the display of the file with the accessed data to a state corresponding to a time of the corresponding one of the plurality of time intervals.

19. A computer program product embodied in a non-transitory computer readable medium and comprising computer instructions for:
displaying a file and a visual indicator of activity associated with a file, the visual indicator being presented as a function of time, wherein the visual indicator of activity indicates a frequency of accesses over a plurality of time intervals;
presenting an element associated with the visual indicator, wherein the element is configured to be manipulated by an input device;
manipulating the element associated with the visual indicator to access data associated with one or more versions of the file when the element is positioned relative to a portion of the visual indicator, wherein the relative positioning of the element corresponds to one of the plurality of time intervals; and
in response to said manipulating, modifying the display of the file with the accessed data to a state corresponding to a time of the corresponding one of the plurality of time intervals.
